(19) United States
(12) Patent Application Publication
(10) Pub. No.: US 2021/0271600 A1
(43) Pub. Date: Sep. 2, 2021

(54) DATA STORAGE DEVICE AND OPERATING METHOD THEREOF

(71) Applicant: SK hynix Inc., Icheon (KR)

(72) Inventors: Jung Min CHOI, Icheon (KR); Byung Il KOH, Icheon (KR); Eui Cheol LIM, Icheon (KR)

(21) Appl. No.: 16/917,460

(22) Filed: Jun. 30, 2020

(30) Foreign Application Priority Data
Mar. 2, 2020 (KR) 10-2020-0025993

(51) Int. Cl. G06F 12/0862

(52) U.S. Cl. CPC G06F 12/0862; G06F 2212/602

(57) ABSTRACT

A data storage device may include: a first memory configured to store a plurality of instructions and data required during an application operation; a cache configured to read, from the first memory, first data for operating the application and store the read first data therein; a processor configured to propagate a data read request to the first cache, a prefetcher, or both when a pointer chasing instruction is generated or a cache miss for the first cache occurs while the processor reads one or more instructions of the plurality of instructions and executes an application; and the prefetcher configured to read second data associated with the pointer chasing instruction or the cache miss from the first memory, and propagate the read second data to the cache.

### CROSS-REFERENCES TO RELATED APPLICATION

The present application claims priority under 35 U.S.C. § 119(a) to Korean application number 10-2020-0025993, filed on Mar. 2, 2020, in the Korean Intellectual Property Office, which is incorporated herein by reference in its entirety.

### BACKGROUND

### 1. Technical Field

Various embodiments generally relate to a semiconductor device, and more particularly, to a data storage device and an operating method thereof.

### 2. Related Art

In general, a data storage system may have a DRAM (Dynamic Random Access Memory) structure or an SSD (Solid State Drive) or HDD (Hard Disk Drive) structure. The DRAM has a volatile characteristic and can be accessed on a byte basis, and the SSD or HDD has a nonvolatile characteristic and a block storage structure. The access speed of the SSD or HDD may be thousands or tens of thousands times lower than that of the DRAM.

Currently, the application of SCM (Storage Class Memory) devices is being expanded. The SCM device can be accessed on a byte basis, and support the nonvolatile characteristic of a flash memory and the high-speed data write/read function of the DRAM. Examples of SCM devices include devices using Resistive RAM (ReRAM), magnetic RAM (MRAM), phase-change RAM (PCRAM), and the like.

The main purpose of NDP (Near Data Processing) is to achieve resource saving by minimizing data migration between a host and media.

In the above-described data environment, a processor may access a memory to acquire data required for executing an application. At this time, when the processor accesses the memory in irregular patterns depending on applications executed by the processor, a cache miss may sometimes occur wherein desired data are not acquired from a cache.

### SUMMARY

Various embodiments are directed to a data storage device with enhanced data read performance, and an operating method thereof.

In an embodiment, a data storage device may include: a first memory configured to store a plurality of instructions and data for use by an application; a cache configured to read, from the first memory, first data for use by the application and store the read first data in the cache; a processor configured to propagate a data read request to the cache or a prefetcher when a pointer chasing instruction is generated or a cache miss for the cache occurs while the processor reads one or more instructions of the plurality of instructions and executes the application; and the prefetcher configured to read second data associated with the pointer chasing instruction or the cache miss from the first memory and propagate the read second data to the cache, wherein the prefetcher determines, based on a data read request of a current pointer generated by the processor, a memory address of the first memory for data required for a next operation, reads the data required for the next operation from the first memory based on the determined memory address, and stores the read data required for the next operation in the cache.

In an embodiment, an operating method of a data storage device may include the steps of: executing, by a processor, one or more instructions of a plurality of instructions to request the cache to read first data; transmitting, by the processor, the data read request to a prefetcher when failing to read the first data from the cache; reading the first data requested by the processor from a first memory and storing the read first data in the cache; determining, by the prefetcher based on a data read request of a current pointer generated by the processor, a memory address of the first memory for data required for a next operation; and reading the data required for the next operation from the first memory based on the determined memory address, and storing the read data required for the next operation in the cache.

In an embodiment, an operating method of a data storage device may include the steps of: executing, by a processor, one or more instructions of a plurality of instructions; transmitting a data read request to a cache, a prefetcher, or both when the executed instruction is a pointer chasing instruction; reading first data, requested by the processor, from the first memory and storing the read first data in the cache; determining, by the prefetcher based on a data read request of a current pointer generated by the processor, a memory address of the first memory for data required for a next operation; and reading the data required for the next operation from the first memory based on the determined memory address, and storing the read data required for the next operation in the cache.

In accordance with the embodiments, since data requested by the processor to execute an application are stored in the cache before being requested, a cache miss can be prevented which makes it possible to smoothly execute the application. As a result, it can be expected that the performance of the processor will be improved.

Furthermore, in embodiment, it can be expected that the memory access latency will be shortened when the processor executes a pointer chasing instruction.

### BRIEF DESCRIPTION OF THE DRAWINGS

FIG. 1 illustrates a data storage system in accordance with an embodiment.

FIG. 2 illustrates a 2-tier pooled memory in accordance with an embodiment.

FIG. 3 illustrates a data storage device in accordance with an embodiment.

FIG. 4 illustrates a process in which a prefetcher determines a next address, in accordance with an embodiment.

FIG. 5 illustrates the case in which a memory access time is shortened by the prefetcher in accordance with an embodiment.

FIG. 6 illustrates an operating process of a data storage device in accordance with an embodiment.

FIG. 7 illustrates another operating process of a data storage device in accordance with an embodiment.

### DETAILED DESCRIPTION

Hereinafter, a data storage device and an operating method thereof according to the present disclosure will be described below with reference to the accompanying drawings through exemplary embodiments.

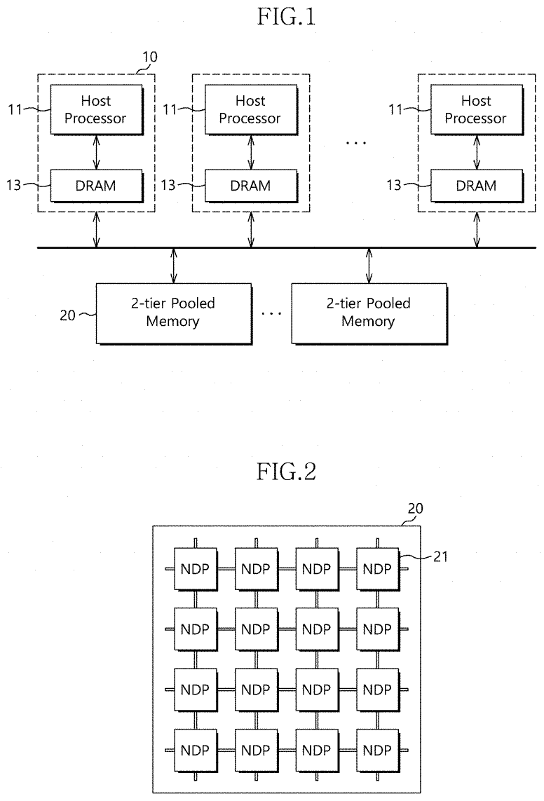

FIG. 1 is a diagram illustrating a configuration of a data storage system in accordance with an embodiment, and FIG. 2 is a diagram illustrating a configuration of a 2-tier pooled memory in accordance with an embodiment.

Referring to FIG. 1, the data storage system may include a host processor 11 and a data storage device 20 for processing a job propagated from the host processor 11. At this time, the host processor 11 may be coupled to a DRAM 13 for storing information associated with the host processor 11.

As illustrated in FIG. 1, the data storage system may include a plurality of computing devices 10 each including the host processor 11 and the DRAM 13. The host processor 11 may include one or more of a CPU (Central Processing Unit), an ISP (Image Signal Processing unit), a DSP (Digital Signal Processing unit), a GPU (Graphics Processing Unit), a VPU (Vision Processing Unit), a FPGA (Field Programmable Gate Array) and a NPU (Neural Processing Unit), or combinations thereof.

As illustrated in FIG. 1, the data storage system may include a plurality of data storage devices 20, each of which is implemented as a 2-tier pooled memory.

Referring to FIG. 2, the 2-tier pooled memory-type data storage device 20 may include a plurality of NDPs (Near Data Processing circuits) 21.

The main purpose of the above-described NDPs 21 is to achieve resource savings by minimizing data migration between a host and media. The NDP can secure an enhanced memory capacity by utilizing a memory pool in a disaggregated architecture, and may off-load various jobs from a plurality of hosts. The priorities of the off-loaded jobs may be different from one another, and the deadlines of the off-loaded jobs, that is, the times by which the off-loaded jobs need to be completed in order to propagate responses to the hosts, may also be different from one another.

A data storage device which is hereafter disclosed may be implemented in the host processor 11 or the NDP 21, but embodiments are not limited thereto.

Hereafter, a data storage device including a cache and prefetcher, which is suitable for pointer chasing of the host processor 11 or the NDP 21, will be presented as an illustrative example.

FIG. 3 is a diagram illustrating a configuration of a data storage device 100 in accordance with an embodiment.

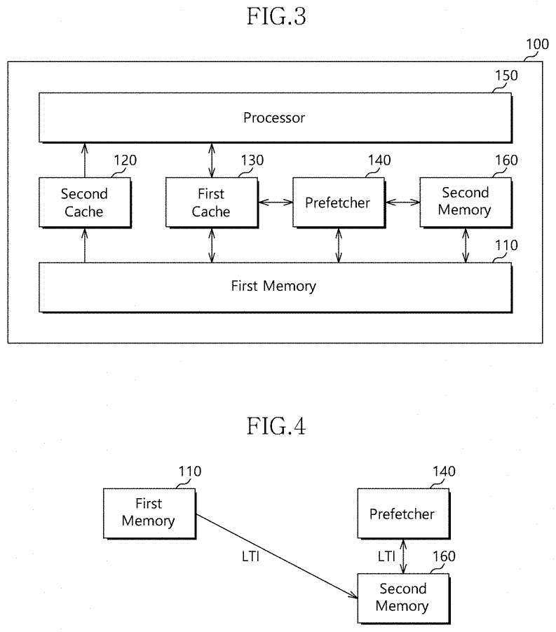

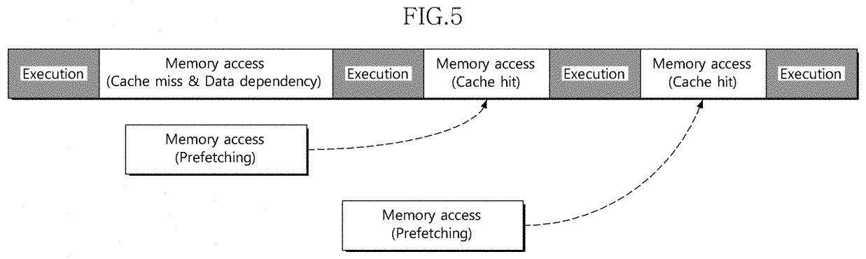

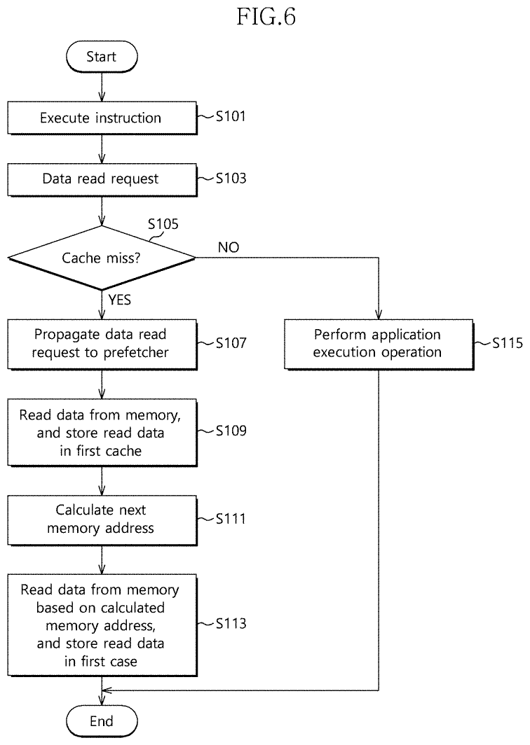

Hereafter, the data storage device 100 will be described with reference to FIG. 4 which illustrates a process in which a prefetcher in accordance with the present embodiment determines a next address, and with reference to FIG. 5 which illustrates the case in which a memory access time is shortened by the prefetcher in accordance with the present embodiment.

Referring to FIG. 3, the data storage device 100 may include a first memory 110, a second cache 120, a first cache 130, a prefetcher 140, a processor 150, and a second memory 160.

The first memory 110 may store a plurality of instructions and data required for an application operation.

The first memory 110 may include a DRAM or SCM or both, but embodiments are not limited thereto.

The second cache 120 may load a plurality of instructions and store the loaded instructions therein. At this time, the second cache 120 may load the plurality of instructions from the first memory 110 and store the loaded instructions therein after the data storage device 100 is booted.

The first cache 130 may read, from the first memory 110, data for operating an application and store the read data therein.

When a data read request results in a cache miss in the first cache 130, the first cache 130 may read, from the first memory 110, the data requested by the data read request that caused the cache miss and store the read data in the first cache 130. Then, the first cache 130 may propagate the data read request to the prefetcher 140.

The first cache 130 may propagate, to the prefetcher 140, a pointer chasing instruction received from the processor 150 or a data read request that causes a cache miss.

In an embodiment, the data read request may be directly propagated to the prefetcher 140 by the processor 150, or in another embodiment may be propagated to the prefetcher 140 through the first cache 130.

When a pointer chasing instruction is generated or a cache miss occurs while the processor 150 reads one or more instructions of the plurality of instructions and executes an application, the processor 150 may propagate a data read request to the first cache 130, the prefetcher 140, or both. The pointer chasing instruction may be generated by the processor 150 when, for example, the processor 150 executes an application that performs a search event using a linked data structure to output a result corresponding to a search word. For example, the pointer chasing may indicate a chasing process which is performed by repeating a process of checking the next pointer through the current pointer and migrating to the checked next pointer. For example, after checking first data of a first pointer in the linked data structure, the processor 150 may determine the memory address of second data based on a second pointer associated with the first pointer, and read a second memory based on the determined memory address of the second data.

The pointer chasing instruction may include an indirect load instruction and a special load instruction. For example, the indirect load instruction may indicate an instruction which refers to a value, stored in an address designated by the instruction, as an address value. The special load instruction is an instruction which is designed to be processed differently from other instructions, according to the needs of a program designer. In an embodiment, the special load instruction may indicate an instruction which is differently processed in relation to pointer chasing. Compared to the indirect load instruction, the processor 150 may immediately recognize the special load instruction as an instruction associated with the pointer chasing instruction. Therefore, the processor 150 may directly propagate a data read request produced by the special load instruction to the prefetcher 140.

When performing the indirect load instruction, the processor 150 may in some cases propagate a data read request to just the first cache 130 or in other cases propagate a data read request to both of the first cache 130 and the prefetcher 140.

On the other hand, when performing the special load instruction, the processor 150 may always propagate a data read request to both of the first cache 130 and the prefetcher 140. That is, as the processor 150 performs the special load instruction associated with a pointer to the prefetcher 140 before a cache miss occurs, the prefetcher 140 may store data, required for pointer chasing, in the first cache 130 in advance, thereby preventing an occurrence of cache miss.

The above-described processor 150 may include one or more of a CPU (Central Processing Unit), ISP (Image Signal Processing unit), DSP (Digital Signal Processing unit), GPU (Graphics Processing Unit), VPU (Vision Processing Unit), FPGA (Field Programmable Gate Array), NPU (Neural Processing Unit) and NDP (Near Data Processing circuit), or combinations thereof.

The prefetcher 140 may read data associated with a pointer chasing instruction or cache miss from the first memory 110, and propagate the read data to the first cache 130.

The prefetcher 140 may determine a memory address of the first memory 110 for data required for a next operation, based on a data read request for the current pointer which was generated by the processor 150. The prefetcher 140 may then read the data corresponding to the determined memory address from the first memory 110 and store the read data in the first cache 130. That is, the prefetcher 140 may pre-generate a data read request based on the determined next address, independent of the operation of the processor 150.

As a result, the period in which the processor 150 performs a calculation may overlap the period in which the prefetcher 140 determines a memory address of data that may be required for a next calculation and reads (that is, prefetches) the data required for the next calculation.

Referring to FIG. 5, while the processor 150 performs an operation other than the load instruction associated with pointer chasing, the prefetcher 140 may pre-generate a read request required for the next operation, read the data required for the next operation from the first memory 110, and store the read data in the first cache 130 (Prefetching in FIG. 5), which makes it possible to expect that memory access latency will be shortened. Since the data required for the next operation is pre-stored by the prefetcher 140 in the first cache 130, it is possible to prevent a cache miss.

The prefetcher 140 may determine the next pointer based on the current pointer using link table information LTI, and check a memory address for data of the determined next pointer.

Referring to FIG. 4, the prefetcher 140 may determine the next pointer to the current pointer based on the link table information LTI stored in the second memory 160, and acquire the address of data matched with the determined next pointer. For this operation, the second memory 160 may have previously read the link table information from the first memory 110 and stored the read link table information therein.

In an embodiment, the link table information may be defined as including a table in which pointers and the addresses of data matched with the pointers are sorted and stored for each application, the pointers being listed in an order that occurs during a linked data traversing process through pointer chasing, the linked data traversing process being performed to execute an application that uses a linked data structure. The linked data structure indicates a data structure composed of a set of data nodes linked through pointers. For example, a search engine chases and provides linked data through pointer chasing, based on input search words, using the above-described linked data structure.

In another embodiment, the prefetcher 140 may determine a memory address of the first memory 110 for data of the next pointer by determining the memory address of data required for the next pointer based on the ranks of neighboring pointers around the current pointer corresponding to a data read request. The ranks of neighboring pointers may refer to ranks allocated according to relative importance to pointers around the current pointer for which data read is requested in the linked data structure.

The prefetcher 140 may search the first cache 130 to check whether data associated with a pointer chasing instruction or cache miss are stored in the first cache 130. When the check result indicates that the data are not present in the first cache 130, the prefetcher 140 may read the data associated with the pointer chasing instruction or the cache miss from the first memory 110, and propagate the read data to the first cache 130.

The prefetcher 140 may search the first cache 130 to check whether data associated with a pointer chasing instruction or cache miss are stored. When the check result indicates that the data are present in the first cache 130, the prefetcher 140 may read data required for a next operation (that is, an operation subsequent to the pointer chasing instruction or cache miss) from the first memory 110, and store the read data in the first cache 130.

The prefetcher 140 may determine the memory address of the data required for the next operation based on a read request for data in which a cache miss occurred, read the corresponding data from the first memory 110 based on the determined memory address, and store the read data in the first cache 130.

The second memory 160 may read link table information for each application from the first memory 110 and store the read link table information therein, but embodiments are not limited thereto. For example, in an embodiment, the processor 150 may read link table information for each application from the first memory 110 and store the read link table information in the second memory 160.

Referring to FIG. 4, the second memory 160 may read the link table information LTI for each application from the first memory 110 and store the read information therein, after the data storage device 100 is booted.

At this time, the link table information may be defined as including a table in which pointers and the addresses of data respectively associated with the pointers are sorted and stored for each application, the pointers being listed in an order that occurs during a linked data traversing process through pointer chasing performed to execute an application based on a linked data structure. Accordingly, when the prefetcher 140 recognizes the current pointer, the prefetcher 140 can determine the next pointer to the current pointer from the link table information for each application, and acquire the address of data associated with the next pointer.

FIG. 6 is a flowchart illustrating a process of operating a data storage device in accordance with an embodiment. The case in which a cache miss occurs will be taken as an example for description.

The processor 150 may execute one or more instructions of a plurality of instructions in step S101, and request the first cache 130 to read data in step S103.

For this operation, the first cache 130 may have previously read data for executing an application from the first memory 110, and have stored the read data therein.

When the processor 150 fails in steps S105 to read data from the first cache 130 (cache miss), the processor 150 may propagate a data read request to the prefetcher 140 in step S107.

Then, the prefetcher 140 may read data requested by the processor 150 from the first memory 110 and store the read data in the first cache 130 in step S109.

Before the prefetcher 140 reads data, the prefetcher 140 may search the first cache 130 to check whether the data is already stored therein. When the check result indicates that the data is not present in the first cache 130, the prefetcher 140 may read data from the first memory 110 and propagate the read data to the first cache 130. At this time, the data may include data corresponding to a read request from the processor 150.

When a cache miss occurred, the first cache 130 may read data from the first memory 110. When the first cache 130 reads data, the first cache 130 may read data, requested by the processor 150, from the first memory 110 and store the read data therein. Then, the first cache 130 may propagate a data read request for the data, in which the cache miss occurred, to the prefetcher 140.

Then, the prefetcher 140 may determine, based on the data read request for the current pointer generated by the processor 150, a memory address of the first memory 110 for data required for a next operation in step S111.

For example, the prefetcher 140 may determine the next pointer to the current pointer based on the link table information, and check a memory address for the data of the determined next pointer.

For this operation, the second memory 160 may have read the link table information for each application from the first memory 110 and stored the read link table information therein, before step S111.

Referring to FIG. 4, the prefetcher 140 may determine the next pointer to the current pointer based on the link table information LTI stored in the second memory 160, and acquire the address of data matched with the next pointer.

At this time, the link table information may be defined as indicating a table in which pointers and the addresses of data matched with the pointers are sorted and stored for each application, the pointers being listed in such an order that is applied during a linked data traversing process through pointer chasing, which is performed to execute an application based on a linked data structure. In an embodiment, when the link table information LTI includes pointers stored in an order of access that occurs during an application, the prefetcher 140 may determine the next pointer as being the pointer stored after the current pointer in the link table information LTI.

In another embodiment, the prefetcher 140 may determine the memory address of data required for the next pointer, based on the ranks of neighboring pointers around the current pointer corresponding to a data read request.

Then, the prefetcher 140 may read the corresponding data from the first memory 110 based on the determined memory address and store the read data in the first cache 130 in step S113. At this time, the prefetcher 140 may pre-generate a data read request based on the determined next address, independent of the operation in the processor 150.

When the check result of step S105 indicates that no cache miss occurs, the processor 150 may perform an application execution operation in step S115. Afterwards, the processor 150 may repeatedly perform the operations beginning at step S101, if necessary.

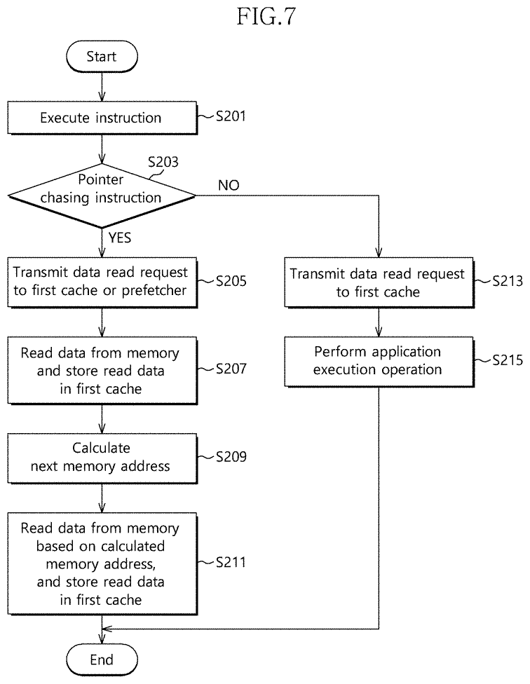

FIG. 7 is a flowchart for describing another process for operating a data storage device in accordance with the present embodiment. The case in which a pointer chasing instruction is generated will be taken as an example for description.

The processor 150 may execute one or more instructions of a plurality of instructions in step S201.

Then, when the executed instruction is determined to be a pointer chasing instruction in step S203, the processor 150 may transmit a data read request to the first cache 130 or the prefetcher 140 in step S205.

The pointer chasing instruction may include one of an indirect load instruction and a special load instruction.

At this time, the indirect load instruction may indicate an instruction that refers to a value, stored in an address designated by the instruction, as an address value. The special load instruction is an instruction which is designed to be processed differently from other instructions, according to the needs of a program designer. In the present embodiment, the special load instruction may indicate an instruction which is differently processed in relation to pointer chasing. Compared to the indirect load instruction, the processor 150 may immediately recognize the special load instruction as an instruction associated with the pointer chasing instruction. Therefore, when the pointer chasing instruction is a special load instruction, the processor 150 may directly propagate a data read request for the special load instruction to the prefetcher 140.

In an embodiment, when the pointer chasing instruction is an indirect load instruction, in step S205 of transmitting the data read request, the processor 150 may transmit the data read request to the first cache 130. In another embodiment, when the pointer chasing instruction is an indirect load instruction, in step S205 of transmitting the data read request, the processor 150 may transmit the data read request to both of the first cache 130 and the prefetcher 140.

When the pointer chasing instruction is a special load instruction in step S205 of transmitting the data read request, the processor 150 may transmit the data read request to both of the first cache 130 and the prefetcher 140.

The data read request can be directly propagated to the prefetcher 140 by the processor 150. However, the data read request may also be propagated to the prefetcher 140 through the first cache 130.

Then, the prefetcher 140 may read data requested by the processor 150 from the first memory 110 and store the read data in the first cache 130 in step S207.

Before the prefetcher 140 reads data, the prefetcher 140 may search the first cache 130 to check whether the data is stored therein. When the check result indicates that the data is not present in the first cache 130, the prefetcher 140 may read data from the first memory 110 and propagate the read data to the first cache 130. At this time, the data may indicate data corresponding to a read request from the processor 150.

When the first cache 130 reads data, the first cache 130 may read data, requested by the processor 150, from the first memory 110 and store the read data therein. Then, the first cache 130 may propagate a data read request, generated by the processor 150, to the prefetcher 140.

Then, the prefetcher 140 may determine, based on the data read request of the current pointer, generated by the processor 150, a memory address of the first memory 110 for data required for a next operation of the processor 150 in step S209.

For example, the prefetcher 140 may determine the next pointer to the current pointer based on the link table information, and check a memory address for data of the determined next pointer.

For this operation, the second memory 160 may have read the link table information for each application from the first memory 110 and stored the read link table information therein before step S209.

Referring to FIG. 4, the prefetcher 140 may determine the next pointer to the current pointer based on the link table information LTI stored in the second memory 160, and acquire the address of data matched with the next pointer.

For another example, the prefetcher 140 may determine the memory address of the first memory 110 for data required for the next pointer, based on the ranks of neighboring pointers around the current pointer corresponding to the data read request.

Then, the prefetcher 140 may read the corresponding data from the first memory 110 based on the determined memory address and store the read data in the first cache 130 in step S211. At this time, the prefetcher 140 may pre-generate a data read request based on the determined next address, independent of the operation of the processor 150.

When the check result of step S203 indicates that the executed instruction is not a pointer chasing instruction, the processor 150 may read data for executing an application from the first cache 130 and store the read data therein in step S213, and then execute the application in step S215.

While various embodiments have been described above, it will be understood to those skilled in the art that the embodiments described are examples only. Accordingly, the data storage device and the operating method thereof, which are described herein, should not be limited based on the described embodiments.

What is claimed is:

1. A data storage device comprising:
a first memory configured to store a plurality of instructions and data for use by an application;
a cache configured to read, from the first memory, first data for use by the application and store the read first data in the cache;
a processor configured to propagate a data read request to the cache or a prefetcher when a pointer chasing instruction is generated or a cache miss for the cache occurs while the processor reads one or more instructions of the plurality of instructions and executes the application; and
the prefetcher configured to read second data associated with the pointer chasing instruction or the cache miss from the first memory and propagate the read second data to the cache,
wherein the prefetcher determines, based on a data read request of a current pointer generated by the processor, a memory address of the first memory for data required for a next operation, reads the data required for the next operation from the first memory based on the determined memory address, and stores the read data required for the next operation in the cache.

2. The data storage device according to claim 1, wherein the period in which the processor performs a current operation overlaps the period in which the prefetcher determines a memory address of the data required for the next operation and reads the data required for the next operation.

3. The data storage device according to claim 1, further comprising a second memory configured to read link table information for each application from the first memory and store the read link table information in the second memory.

4. The data storage device according to claim 3, wherein the prefetcher determines a next pointer corresponding to the current pointer based on the link table information, and checks a memory address for data of the determined next pointer.

5. The data storage device according to claim 1, wherein the pointer chasing instruction comprises an indirect load instruction, and
wherein when generating the indirect load instruction, the processor transmits the data read request of the indirect load instruction to the cache or transmits the data read request of the indirect load instruction to both of the cache and the prefetcher.

6. The data storage device according to claim 1, wherein the pointer chasing instruction comprises a special load instruction, and
wherein when generating the special load instruction, the prefetcher transmits the data read request of the special load instruction to both of the cache and the prefetcher.

7. The data storage device according to claim 1, wherein the prefetcher searches the cache to check whether data associated with the pointer chasing instruction or the cache miss is stored in the cache, and reads the data associated with the pointer chasing instruction or the cache miss from the first memory and propagates the read data to the cache when the check result indicates that the data is not present in the cache.

8. The data storage device according to claim 1, wherein the prefetcher searches the cache to check whether the second data associated with the pointer chasing instruction or the cache miss is stored in the cache, and reads the data required for the next operation from the first memory and stores the read data required for the next operation in the cache when the check result indicates that the second data is present in the cache.

9. The data storage device according to claim 1, wherein when the cache miss occurred, the cache reads data for which the cache miss occurred from the first memory and stores the read data for which the cache miss occurred in the cache, and propagates a data read request for the data for which the cache miss occurred to the prefetcher.

10. The data storage device according to claim 9, wherein the prefetcher determines a memory address of the data required for the next operation based on a read request for the data for which the cache miss occurred, reads the data required for the next operation from the first memory based on the determined memory address, and stores the read data required for the next operation in the cache.

11. The data storage device according to claim 1, wherein the cache propagates to the prefetcher a data read request when the pointer chasing instruction is received from the processor or a cache miss occurs.

12. The data storage device according to claim 1, wherein the first memory is a DRAM (Dynamic Random Access Memory) or SCM (Storage Class Memory).

13. An method of operating a data storage device, the method comprising:
executing, by a processor, one or more instructions of a plurality of instructions to request the cache to read first data;
transmitting, by the processor, the data read request to a prefetcher when failing to read the first data from the cache;
reading the first data requested by the processor from a first memory and storing the read first data in the cache;
determining, by the prefetcher based on a data read request of a current pointer generated by the processor, a memory address of the first memory for data required for a next operation; and
reading the data required for the next operation from the first memory based on the determined memory address, and storing the read data required for the next operation in the cache.

14. The operating method of claim 13, further comprising reading link table information for an application from the first memory and storing the read link table information in a second memory before determining the memory address,
wherein determining the memory address includes determining a next pointer corresponding to the current pointer from the link table information, and checks a memory address for data of the determined next pointer.

15. The operating method according to claim 13, wherein reading the data required for the next operation and storing the read data required for the next operation in the cache comprises the steps of:
checking, by the prefetcher, the cache to check whether the data required for the next operation is stored in the cache; and
reading the data required for the next operation from the first memory and propagating the read data required for the next operation to the cache when the check result indicates that the data required for the next operation is not present in the cache.

16. The operating method according to claim 13, wherein reading the first data requested by the processor and storing the read first data in the cache comprises the step of reading, by the cache, the first data requested by the processor from the first memory and storing the read first data in the cache, and propagating a data read request for the first data to the prefetcher.

17. An method of operating a data storage device, the method comprising:
executing, by a processor, one or more instructions of a plurality of instructions;
transmitting a data read request to a cache, a prefetcher, or both when the executed instruction is a pointer chasing instruction;
reading first data, requested by the processor, from the first memory and storing the read first data in the cache;
determining, by the prefetcher based on a data read request of a current pointer generated by the processor, a memory address of the first memory for data required for a next operation; and
reading the data required for the next operation from the first memory based on the determined memory address, and storing the read data required for the next operation in the cache.

18. The operating method according to claim 17, wherein the pointer chasing instruction comprises an indirect load instruction,
wherein the step of transmitting the data read request comprises the step of transmitting the data read request to the cache or transmitting the data read request to both of the cache and the prefetcher, when the pointer chasing instruction is the indirect load instruction.

19. The operating method according to claim 17, wherein the pointer chasing instruction comprises a special load instruction,
wherein the step of transmitting the data read request comprises the step of transmitting the data read request to both of the cache and the prefetcher, when the pointer chasing instruction is the special load instruction.
